(19) United States
(12) Patent Application Publication
(10) Pub. No.: US 2023/0417557 A1
(43) Pub. Date: Dec. 28, 2023

(54) Improved Timing and Trilateration System for Space Applications and Associated Methods

(71) Applicant: Impulse Space, Inc., El Segundo, CA (US)

(72) Inventors: Barry Matsumori, Rolling Hills Estates, CA (US); Carl Haken, El Segundo, CA (US)

(73) Assignee: Impulse Space, Inc., El Segundo, CA (US)

(21) Appl. No.: 18/210,482

(22) Filed: Jun. 15, 2023

Related U.S. Application Data
(60) Provisional application No. 63/355,724, filed on Jun. 27, 2022.

(51) Int. Cl. G01C 21/24; G01T 1/36

(52) U.S. Cl. CPC G01C 21/24; G01T 1/36

(57) ABSTRACT

A pulsar-based timing and lateration system includes a detector system. In according with certain embodiments, the detector system includes a plurality of detectors, each one configured for detecting X-ray photons and generating output signals according to the X-ray photons detected, and an electronics unit for receiving and analyzing the output signals from the detectors. The electronics unit includes a processor for analyzing the output signals received from the detectors. A first detector is aimed toward a first pulsar such that the X-ray photons detected at the first detector includes pulsar signals from the first pulsar. The processor includes a memory for storing a library of data related to electromagnetic emissions of known pulsars. The processor isolates the pulsar signals from the first pulsar, and determines position and velocity of the system by comparing the isolated pulsar signals to the library of data.

### REFERENCE TO RELATED APPLICATIONS

The present application claims the benefit of U.S. Pat. App. No. 63/355,724, filed 2022 Jun. 27 and titled “Improved Timing and Trilateration System for Space Applications and Associated Methods,” which is incorporated hereby in its entirety by reference.

### FIELD OF THE INVENTION

Aspects of the present disclosure generally relate to positioning, navigation, and timing (PNT) systems and, more specifically, to PNT systems for use in extraterrestrial applications.

### DESCRIPTION OF RELATED ART

Various efforts to use known pulsars for space navigation has been ongoing since the 1960s. Ongoing research efforts, such as X-ray pulsar source-based navigation and timing (“XNAV”) projects in the early 2000s and the more recent Station Explorer for X-ray Timing and Navigation Technology (“SEXTANT”) project by NASA, have yielded promising proof of concept experimental results. However, these results have been obtained using large X-ray telescopes the size of commercial washing machines, thus are impractical for use in payload-constrained applications.

More recent efforts (see, for example, Xu reference listed below) have explored the use of silicon drift detectors (SDDs) for X-ray pulsar navigation. However, these projects have only validated working principles, without concern for how a system based on SDDs may be implemented on a working spacecraft.

Thus, there is a need for an improved PNT system that takes advantage of the availability of pulsar data.

The following publications are incorporated herein by reference in their entirety.
Cheung, et al., “A Trilateration Scheme for Relative Positioning,” 2017 IEEE Aerospace Conference Big Sky, Montana, March 2017
(https://trs.jpl.nasa.gov/bitstream/handle/2014/47332/CL %2316-6231.pdf?sequence=1, accessed 2022-06-07).
Melissa Gaskill, “Future Space Travelers May Follow Cosmic Lighthouses,” NASA Update, Jun. 21, 2020 (https://www.nasa.gov/mission_pages/station/research/news/future-space-travelers-may-follow-cosmic-lighthouses-sextant-results, accessed 2022-06-07).
Getchius, et al., “Predicted Performance of an X-ray Navigation System For Future Deep Space and Lunar Missions,” American Astronautical Society, 42nd Annual Guidance and Control Conference, Breckenridge, CO, 2019
(https://ntrs.nasa.gov/api/citations/20190001154/downloads/20190001154.pdf, accessed 2022-06-07).
Graven, et al., “XNAV for Deep Space Navigation,” 31st Annual AAS Guidance and Control Conference, Breckenridge, Colorado, 2008
(https://www.asterlabs.com/publications/2008/Graven_et_al,_AAS_31_GCC_February_2008.pd f, accessed 2022-06-07).
Litchford, “SEXTANT—Station Explorer for X-ray Timing & Navigation Technology,” 593rd WE-Heraeus Seminar, June 8-11, 2015, presentation
(https:fintrs.nasa.govicitations/20150016427, accessed 2022-06-07).
David McMillen, “An Analysis of Position Probability Distributions of Trilateration and Triangulation for Extremely Deep Space Navigation,” University of Michigan, Research Experience for Undergraduates paper, 2011
(http://dept.mathisa.umich.edu/undergrad/REU/ArchivedREUpapers/2011%20Papers/David %2 accessed 2022-06-07).
Mitchell, et al., “SEXTANT—Station Explorer for X-Ray Timing and Navigation Technology,” American Institute of Aeronautics and Astronautics, NASA Technology Report 2015 (https://ntrs.nasa.gov/api/citations/20150001327/downloads/20150001327.pdf, accessed 2022-06-07).
Oxford Instruments, “Silicon Drift Detectors Explained,” Oxford Instruments publication 2012 (https://www.exviLlt/wp-content/uploads/2012/04/SDD_Explained.pdf, accessed 2022-06-07).
Sala, et al., “Pulsar Navigation,” uploaded to ResearchGate
(https://www.researchgate.net/publication/228594412_Pulsar_Navigation accessed 2022-06-07).
Tan, “High-Mass X-ray binary: Classification, Formation, and Evolution,” J. Phys. Conf. Ser., Vo. 2012, 012119, ICM MAP 2021, 012119, 2021.
Vidal, “What if extraterrestrials had a galactic GPS,” published 2 May 2022 (http://www.clemvidal.com/blog/2022/5/2/what-if-extraterrestrials-had-a-galactic-gps accessed 2023-01-31).
Winternitz, et al., “X-ray Pulsar Navigation Algorithms and Testbed for SEXTANT,” NASA Technology Report, 2015
(https://ntrs.nasa.gov/api/citations/20150000812/downloads/20150000812.pdf, accessed 2022-06-07).
Xu, et al., “Silicon drift detector applied to X-ray pulsar navigation,” Nuclear Instruments and Methods in Physics Research Section A: Accelerators, Spectrometers, Detectors and Associated Equipment, Volume 927, 21 May 2019, Pages 429-434.
Yan, et al., “Multi-Wavelength Study of the Be/X-Ray Binary MXB 0656-072,” The Astrophysical Journal, Volume 753, No. 73, 1 Jul. 2012, pp. 1-11.
Yu, et al., “NASA SEXTANT Mission Operations Architecture,” NASA Technical Reports IAC-19.63.4-66.4.2, 2019
(https://ntrs.nasa.gov/api/citations/20190031975/downloads/20190031975.pdf, accessed 2022-06-07).

### SUMMARY OF THE INVENTION

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an aspect, embodiments of a pulsar-based timing and lateration system is disclosed.

In another aspect, embodiments of methods of using a pulsar-based timing and lateration system is disclosed.

In an embodiment, a pulsar-based timing and lateration system includes a detector system. The detector system in turn includes a plurality of detectors, each one of the plurality of detectors being configured for detecting X-ray photons and generating output signals according to the X-ray photons so detected. The detector system also includes an electronics unit for receiving and analyzing the output signals from the plurality of detectors. The electronics unit includes a processor for analyzing the output signals received from the plurality of detectors. A first one of the plurality of detectors is aimed toward a first pulsar such that the X-ray photons detected at that one of the plurality of detectors includes pulsar signals from the first pulsar. The processor includes a memory for storing a library of data related to electromagnetic emissions of known pulsars. In certain embodiments, the processor is configured for isolating the pulsar signals from the first pulsar, and determining position and velocity of the system by comparing the pulsar signals from the first pulsar so isolated to the library of data.

In still another aspect, a method for using a pulsar-based timing and lateration system is described. The pulsar-based timing and lateration system includes a detector system. The method includes determining a plurality of pulsars for use in a positioning process, using detector system for detecting the plurality of pulsars, and further using the detector system for determining location data of the detector system with respect to the plurality of pulsars.

In an embodiment, the detector system is a first detector system and the pulsar-based timing and lateration system further includes a second detector system. The method further includes transferring the location data of the first detector system to the second detector system, using the second detector system to determine location data of the second detector system with respect to the plurality of pulsars, and refining the location data of the second detector system to generate a refined location data of the second detector system by comparing the location data of the first detector system with the location data of the second detector system with respect to the plurality of pulsars.

In a further embodiment, using the detector system includes selecting a specific pulsar from the plurality of pulsars and collecting X-ray photons from a general direction of the specific pulsar so selected. Using the detector system further includes isolating a pulsar signal from the X-ray photons so collected, and analyzing the pulsar signal to determine at least one of positioning information, navigation information, and timing information of the detector system.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

The appended drawings illustrate only some implementation and are therefore not to be considered limiting of scope.

FIG. 1 illustrates a pulsar-based timing and lateration system, in accordance with an embodiment.

FIG. 2 illustrates an exemplary multi-directional detector system suitable for use with the pulsar-based timing and lateration system of FIG. 1, in accordance with an embodiment.

FIG. 3 illustrates an exemplary dual-axis gimbal-mounted detector suitable for use with the pulsar-based timing and lateration system of FIG. 1 and/or within the multi-directional detector system of FIG. 2, in accordance with an embodiment.

FIG. 4 is a flow diagram of a method of lateration using a pulsar-based timing and lateration system, in accordance with an embodiment.

FIG. 5 illustrates an exemplary pulsar-based timing and lateration system including multiple detector systems, in accordance with an embodiment.

FIG. 6 is a flow diagram of a method for location data refinement using multiple detector systems, in accordance with an embodiment.

FIG. 7 is a flow diagram of a method for isolating pulsar signals from background X-ray signals, in accordance with an embodiment.

FIG. 8 is a flow diagram of a method for performing pulsar-based trilateration and, optionally, position-navigation-timing (PNT) calculation, in accordance with an embodiment.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numeral in different figures denote the same element.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

### DETAILED DESCRIPTION OF THE INVENTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The well characterized and predictable x-ray emissions from pulsars should make them ideal beacons for use in establishing PNT information, even independently of earthbound ground stations and existing global positioning networks, such as the Global Positioning Satellite network and similar satellite constellations in orbit around the earth. It is noted that various publications, such as those listed in the Background section above, discuss the use of pulsars for navigation or the general concept of trilateration for navigation. The present disclosure, in contrast, describe embodiments of a navigation and trilateration system, which uses pulsars as timing sources along with multiple space vehicles for receiving the timing signals and broadcasting signals to each other to enable trilateration-based guidance.

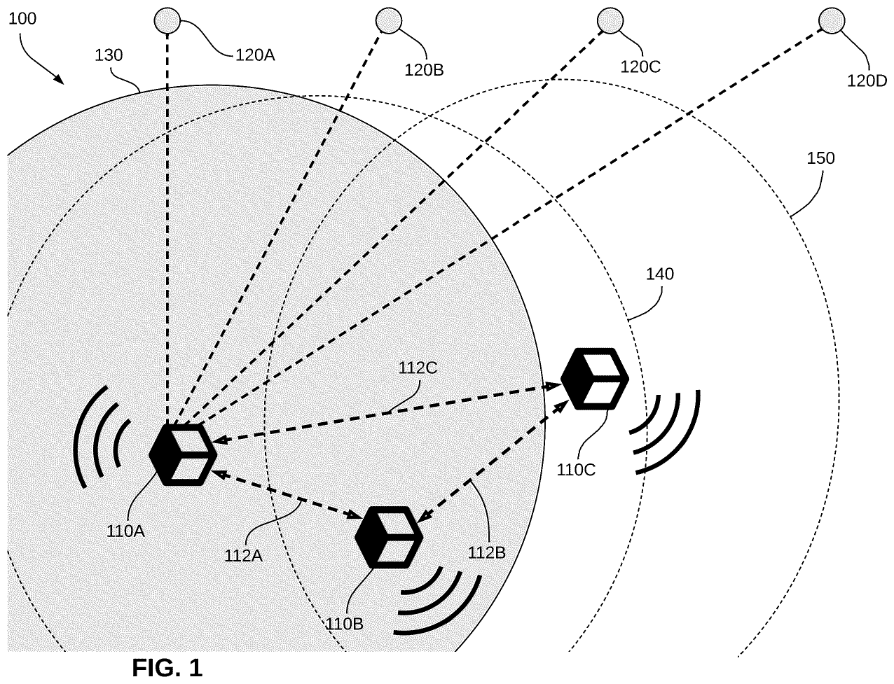

FIG. 1 illustrates a pulsar-based navigation system, in accordance with an embodiment. As shown in FIG. 1, a navigation system 100 includes a first transceiver 110A, a second transceiver 110B, and a third transceiver 110C. The first, second, and third transceivers are configured for measuring X-ray emissions from pulsars and broadcasting signals according to the received emission to external locations, including amongst each other as indicated by the three-arc symbols and double-headed arrows 112A, 112B, and 112C. In an example, first transceiver 110A is configured to simultaneously observe a first pulsar 120A, a second pulsar 120B, a third pulsar 120C, and a fourth pulsar 120D with well-known position and X-ray signal frequency characteristics. Second transceiver 110B and third transceiver 110C may also be configured for simultaneously or sequentially observing pulsars 120A, 120B, 120C, and 120D. As the signal characteristics that should be observable at the first, second, and third transceivers are well-known, the timing and other characteristics of the observed pulsar signals (e.g., timing, frequency, relative phase) at each one of the first, second, and third transceivers can be used to calculate the initial locations of these transceivers.

First, second, and third transceivers 110A, 110B, and 110C are further configured for communicating with each other (e.g., as shown by double-headed arrows 112A, 112B, and 112C) so as to share the initial locations of the first, second, and third transceivers 110A, 110B, and 110C as well as the observed pulsar signals, thus enabling the measurement of the distances between the first, second, and third transceivers and, thus, trilateration. That is, the measured timing of the pulsar signals may be combined with the distance information to enable navigation of the satellites containing first, second, and third transceivers 110A, 110B, and 110C. First, second, and third transceivers may also be configured to send signals out to external locations, such as transceivers mounted at ground stations and/or other spacecraft, as indicated by the three-arc symbols. In certain embodiments, first transceiver 110A may act as a communication hub such that first transceiver 110A communicates with the second and third transceivers, and is further configured to communicate with objects (e.g., ground stations, ground vehicles, satellites, spacecraft), as indicated by the “three arcs” symbol in FIG. 1.

In an example, each one of the first, second, and third transceivers may be contained within satellites in known orbital paths around a celestial object 130, such as Earth or another planet or star. Based on the shared timing and location information between the different transceivers, the measured data may be used for navigating one or more of the satellites containing the transceivers to different orbits, such as a first orbit 140 and a second orbit 150 as shown in FIG. 1.

The use of pulsar emissions to calculate location data is advantageous as such X-ray signal detection and calculation may be performed in space, where signal distortion due to atmospheric disturbance s are much reduced compared to terrestrial applications of GPS systems. Further, the X-ray emissions from pulsars are known to be highly predictable and well characterized, compared to reliance on man-made signal sources such as GPS satellites. The calculation of the positions and use of the data in navigation are described in various publications, such as those listed above. A multitude of detectors may be positioned at different angles within each transceiver to enable simultaneous measurement of signals from multiple pulsars, as will be further described below.

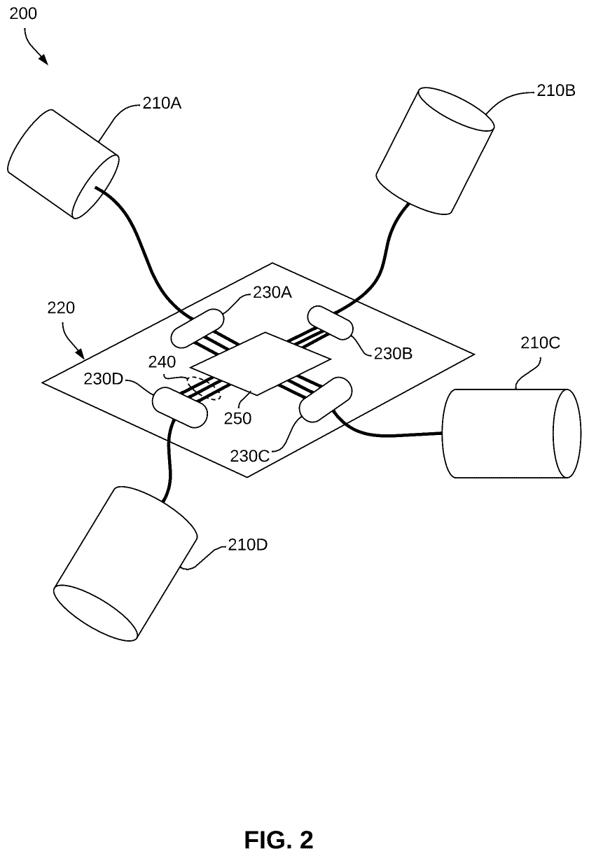

FIG. 2 illustrates an exemplary multi-directional detector system suitable for use with the pulsar-based timing and lateration system of FIG. 1, in accordance with an embodiment. As shown in FIG. 2, a detector system 200 includes a plurality of silicon drift detectors (SDDs), shown as a first SDD 210A, a second SDD 210B, a third SDD 210C, and a fourth SDD 210D. Each SDD may be, for example, a commercially available X-ray detecting device, such as those available from Oxford Instruments, AmpTek, Hitachi, and elsewhere. In an embodiment, a critical performance requirement of the SDD is its timing accuracy, i.e., how accurately the SDD records the time when an X-ray photon is detected. For example, timing accuracy of approximately 100 nanoseconds or better would be desirable for an SDD used in accordance with the described embodiments herein. However, timing accuracy of approximately one microsecond may be sufficient for certain pulsar-based timing and lateration embodiments.

It is noted that commercial SDD manufacturers often tout their SDDs' capabilities for differentiating between different X-ray photon energy levels. While such capabilities to distinguish between X-rays having different photon energy levels are important for X-ray fluorescence (XRF) applications, this feature is not crucial for the implementation of pulsar-based timing and lateration systems described herein. Further, modern commercial SDDs are capable of operating without cryogenic cooling, which feature makes them suitable for space- and power-constrained applications such as for space navigation.

Returning to FIG. 2, each SDD is mounted at a different angle with respect to each other SDD to enable simultaneous observation of different pulsars. In the example illustrated in FIG. 2, the signals detected at the SDDs are directed to an electronics unit 220. The signals from the SDDs are converted to digital signals at specialized analog-to-digital (A/D) converters (i.e., a first A/D converter 230A associated with first SDD 210A, a second A/D converter 23013 associated with second SDD 210B, a third A/D converter 230C associated with third SDD 210C, and a fourth A/D converter 230D associated with fourth SDD 210D), then directed via connections 240 to a processor 250, which performs the analysis for identifying a specific pulsar signal from other sources of X-ray energy. The signal processor would use several steps to isolate the pulsar signal. The first step is to isolate the wavelength of the pulsar of interest.

Pulsars will emit across many bands of the electromagnetic spectrum, but to minimize the filtering of spectrum, focusing on X-ray is preferred. Within X-ray spectrum, the bandwidth is wide, so the processing should focus on the specific wavelength of interest. This will eliminate much of the spectrum to be analyzed and focus on a pulsar of interest. Next step is to eliminate those signals that do not approximate the repeating nature of the pulsar X-ray signal as such signals are originating from a non-pulsar source. Doing so will isolate the signal to the pulsar of interest. Each SDD will have their respective signal processed to match the pulsar of interest.

For instance, first SDD 210A may be pointed at first pulsar 120A of FIG. 1, second SDD 210B is pointed at second pulsar 1206, and so on. In an example, the SDDs are mounted at fixed angles with respect to one another such that four pre-selected pulsars can be observed at once. In this way, the frequency and relative phase of the observed X-ray emissions from the different pulsars may be used to precisely determine the position and velocity of the detector system (and thus of the object on which the detector system is mounted, such as a spacecraft or satellite).

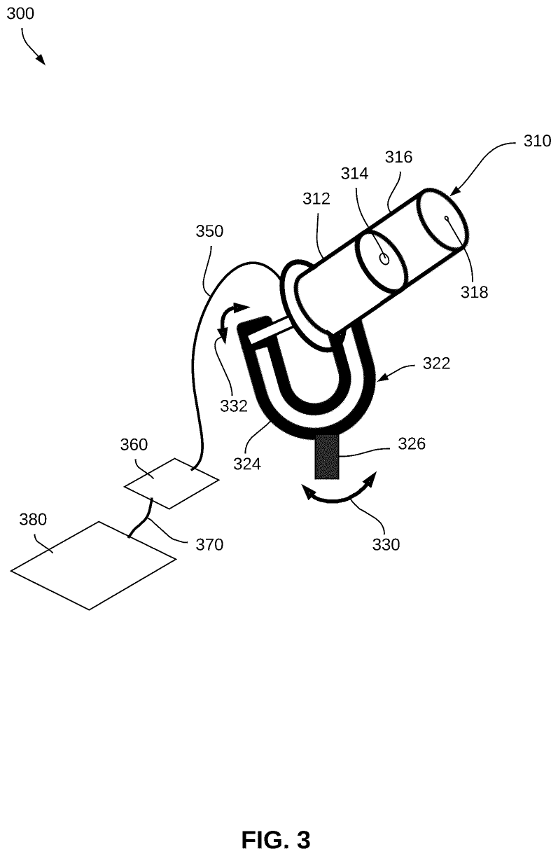

In another example, the SDDs are mounted on adjustable mounting mechanisms for moving the SDD pointing angles to change the specific pulsar being observed or to continue pointing at a specific pulsar while the detector system (if mounted, for example, on a moving spacecraft or satellite) is in transit. FIG. 3 illustrates an exemplary dual-axis gimbal-mounted detector suitable for use with the pulsar-based timing and lateration system of FIG. 1 and/or within the multi-directional detector system of FIG. 2, in accordance with an embodiment.

As shown in FIG. 3, a detector system 300 includes a detector 310, such as an SDD. Detector 310 includes a detector body 312 with a sensor unit 314. An aperture unit 316 is optionally attached to detector body 312. Aperture unit 316 includes a small aperture 318, which restricts the observed X-rays to a very narrow viewing angle and blocks stray X-rays from reaching sensor unit 314. Detector body 312 is affixed to a mounting system 322, shown in the illustrated embodiment with a U-arm 322 and a post 326. Mounting system 322 is adjustable such that detector body 312 may be rotated in the directions represented by double-headed arrows 330 and 332. The X-ray signals received at sensor unit 314 is sent via a connector 350 to an A/D converter 360, then directed via one or more connections 370 to a processor 380 for the trilateration and positioning calculations.

In an example, each gimbal-mounted detector body may replace one or more of the fixed SDDs of FIG. 2 such that multiple pulsars may be observed simultaneously. Alternatively, detector system 300 may be used in place of detector system 200 as a whole. In such a case, detector body 312 may be sequentially pointed at different pulsars, measuring the frequency and relative phase of the signals emitted from each pulsar. The data from multiple pulsars, collected sequentially, may then be aggregated to calculate the position and velocity of the object on which the detector system is mounted. The use of a single sensor unit to sequentially gather X-ray emission data from multiple pulsars is advantageous as such a configuration would enable significant reduction in the size, weight, and power consumption (SWAP) of the detector system, thus enabling a wider applicability of the detector system in volume and weight constrained applications, such as on spacecraft and payloads launched into space or for space exploration.

It is noted that, while the mounting mechanism shown in FIG. 3 is a two-axis gimbal, other adjustable mounting mechanisms may be used. Optionally, a two-axis gimbal may be actuated by mechanical or electronic means, such as a motor with a gearbox, a stepper motor, or a piezoelectric gimbal motor. Further, while the two-axis gimbal in FIG. 3 is illustrated as U-bracket mounted on a rotating stem, other styles of gimbals may alternatively be used.

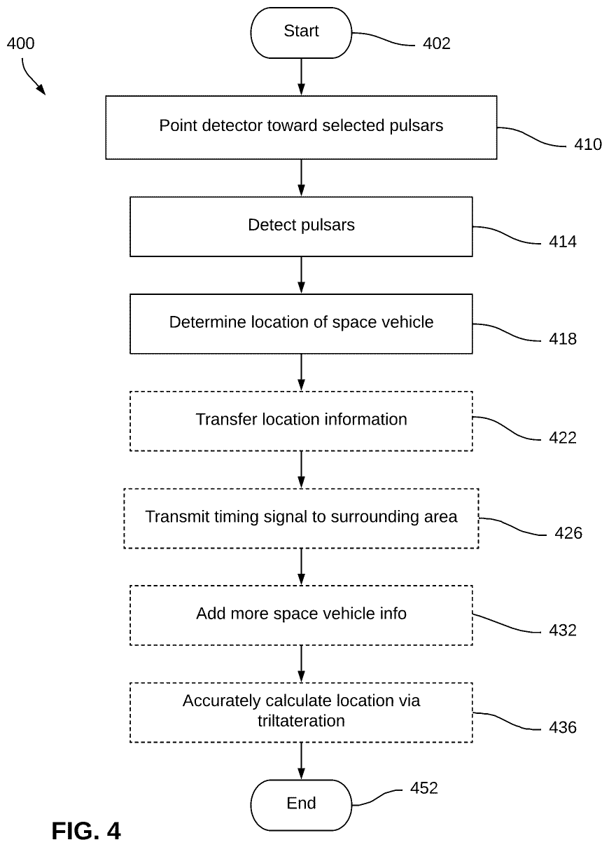

FIG. 4 is a flow diagram of a method of lateration using a pulsar-based timing and lateration system, in accordance with an embodiment. As shown in FIG. 4, a process 400 begins with a start step 402, then proceeds to a step 410 to point the detector system (e.g., one of the detector systems described above) toward pulsars. For example, the specific pulsars to be used for the positioning process may have been selected during the design of the timing and lateration system out of the known constellation of pulsars with known emission data. In other embodiments, the known attitude of the timing and lateration system location (e.g., a vehicle on which the timing and lateration system is mounted) and known celestial locations of pulsars may be used to point the detector system toward known pulsars suitable for use with the timing and lateration system. Various publicly available databases of pulsar emission data exists in scientific literature, such as those produced by NASA, with extensive data related to approximately 40 pulsars to date.

The pulsars selected in step 410 are observed by a detector system in a step 414 to gather data related to, for example, the X-ray emission frequency and relative phase from observation of multiple pulsars. The use of a gimbaled detector system, such as illustrated in FIG. 3, would require sequential observation of multiple pulsars in a controlled manner to aggregate the necessary data for trilateration.

The collected pulsar data are then used to determine the location (or other location, positioning, and velocity information) of the space vehicle or satellite on which the detector system is mounted in a step 418. The extraction of trilateration data from pulsar data may be performed using, for example, known algorithms published in the scientific literature, while taking into account the motion of the object onto which the detector system is mounted.

Process 400 then proceeds to optional step 422 to transfer the location information, so calculated, to objects in the surrounding area. Similarly, detector system may also transmit a timing signal to the surrounding area in a step 426. The transmitted location and timing data may be received by other objects (e.g., spacecraft, satellite, or other space vehicles) to aggregate the data over multiple objects, thus improving the accuracy of the location and timing information. For example, three space vehicles generating and sharing location and timing signals would enhance the accuracy of the trilateration calculations. The strength of the transmitted signal may be adjusted, depending on the specific application (e.g., from geostationary or geosynchronous equatorial orbit (GEO), or from a lunar orbit to a location on the lunar surface). The transmitted signal may also be modified, depending on the specific atmospheric conditions through which the signal is intended to be transmitted (e.g., through an atmospheric storm on Mars). Finally, the location of the detector system may be accurately calculated using known trilateration processes based on the shared location and timing data in a step 432, and the process ends in an end step 452.

It is noted that either sequential observation of different pulsars or simultaneous observation of multiple pulsars may be performed as part of process 400. The lateration algorithms performed by the timing and lateration system described herein relies on highly accurate timestamping of the observed X-ray radiation, along with the efficient transmission of the timing data to the physically separated objects, such as transceivers110A, 110B, and 110C shown in FIG. 1.

As an example, when process 400 is used with multiple space vehicles (or satellites or other moving objects with a view of multiple pulsars), the location of each space vehicle is determined using a pulsar detector in step 418. The location data is processed and transferred to a location internally within the space vehicle in step 422. The location of each space vehicle is broadcast to a receiving satellite or vehicle (e.g., a spacecraft in space or a vehicle operating on a planetary surface) in step 426 as a source of timing information. By aggregating location and timing information from multiple space vehicles in step 432, accurate trilateration process may be performed in step 436.

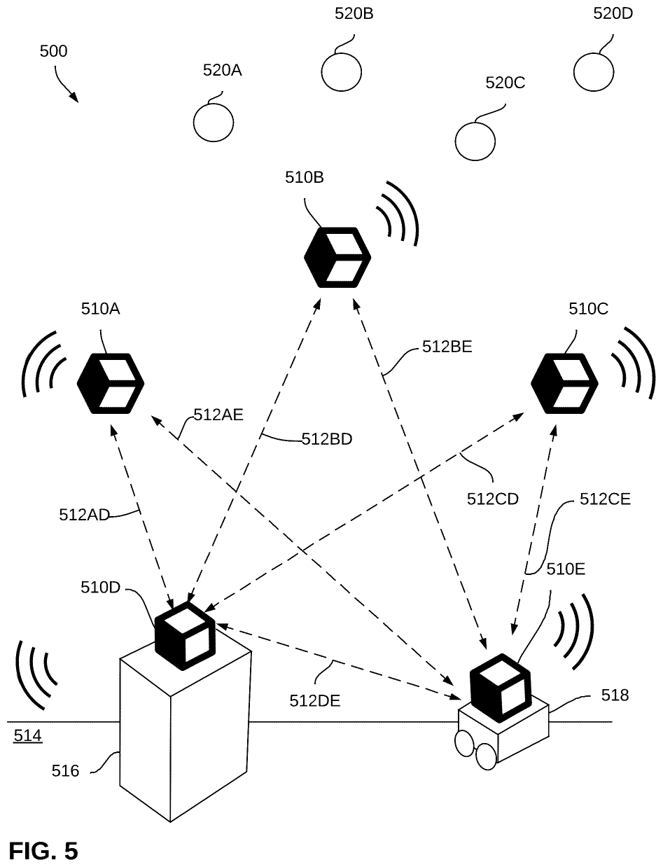

FIG. 5 illustrates an exemplary pulsar-based timing and lateration system including multiple detector systems, in accordance with an embodiment. As shown in FIG. 5, a navigation system 500 includes a first transceiver 510A, a second transceiver 510B, a third transceiver 510C, a fourth transceiver 510D, and a fifth transceiver 510E. The five illustrated transceivers each includes a communication unit (not shown) such that each transceiver is capable of communication with each other transceiver, as indicated by three-arc symbols and dashed double arrows 512AD, 512AE, 512BD, 512BE, 512CD, 512CE, and 512DE, by optical, RF, and other communication methods for short- and long-range signal transmission. First, second, and third transceivers 510A, 510B, and 510C, respectively, are shown integrated into or mounted on satellites or aerial objects, in the illustrated example. Fourth transceiver 510D is shown to be positioned on a surface 514 (earth or a non-earth planet, as a nonlimiting example) on a ground station 516. Fifth transceiver 510E is shown mounted on a ground vehicle 518.

Continuing to refer to FIG. 5, each one of the five illustrated transceivers includes a detector system (e.g., as shown in FIGS. 2 and 3) configured for measuring X-ray emissions from pulsars (e.g., first pulsar 520A, second pulsar 520B, third pulsar 520C, and fourth pulsar 520D in FIG. 5) and broadcasting signals according to the received emission to external locations, including amongst each other as indicated by the three-arc symbols and double-headed arrows. For instance, first, second, and third transceivers 510A, 510B, and 510C, respectively, may be configured to obtain emission information from first, second, third, and fourth pulsars 520A, 520B, 520C, and 520D, then transmit the calculated timing and lateration information to fourth transceiver 510D and/or fifth transceiver 510E. Optionally, first, second, and third transceivers 510A, 510B, and 510C, respectively, may communicate directly with each other, although such data paths are not required in the operation of the timing and lateration system described herein.

In an example, each one of the five transceivers may include a memory for storing a library of data related to pulsar emissions, and a processor for processing and comparing the pulsar signals received at each detector system to known pulsar emissions to calculate location data for that detector system. For instance, each transceiver may obtain X-ray emissions from four different pulsars, either simultaneously or sequentially, and all of the transceivers may obtain X-ray emissions from the same set of four different pulsars to operate. In other embodiments, different transceivers may observe different sets of pulsars to obtain timing and lateration data; for example, a first one of the transceivers may observe pulsars A, B, C, and D, while a second one of the transceivers may observe pulsars A, B, C, and E. Further, a third one of the transceivers in the same timing and lateration system may observe pulsars F, G, H, and I. In certain embodiments, more than four pulsars may be observed, simultaneously or in sequence, by one or more of the transceivers, which may further improve the accuracy of the calculated timing and/or lateration information extracted from the observed pulsar data.

In certain embodiments, the processor may further isolate the pulsar-specific detected signal from the background signals by using frequency or wavelength filtering. The five transceivers may also share the calculated location data therebetween in order to further refine the respective location data to provide accuracy beyond that possible with a single transceiver.

By selecting the location data calculated at three out of the five transceivers of navigation system 500, the measurement of the distances between the three selected transceivers may be calculated by a tri-lateration process. Further, by periodically, randomly, or pseud-randomly selecting a different set of three transceivers from which to gather data for the tri-lateration process, an extra layer of security and encryption may be provided by navigation system 500 over existing navigation systems based on fixed data sources, such as GPS satellites, that may be readily disrupted.

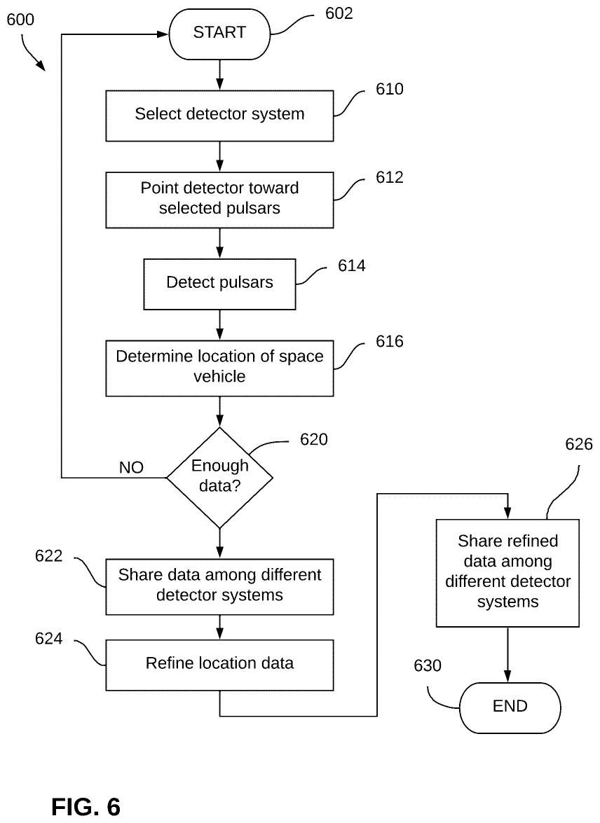

FIG. 6 is a flow diagram of a method for location data refinement using multiple detector systems, in accordance with an embodiment. As shown in FIG. 6, a process 600 begins with a start step 602, then proceeds to a step 610 to select a specific detector system for pulsar data collection. The detector system is pointed toward specific pulsars to observe in a step 612. The selected detector system then detects the selected pulsars in a step 614, then the location of the space vehicle (or the location on which the detector system is mounted) is determined in a step 616. A decision 620 is made whether enough data has been collected for the intended use of the overall navigation system. For example, as described above, if refined location data or PNT data is to be calculated, pulsar data may need to be collected by three or more detector systems. If the answer to decision 620 is NO, not enough data have been gathered, then process 600 returns to step 610 to select another detector system for use in pulsar data collection. If decision 620 determines YES, enough data has been collected, then the collected data are shared among different detector systems in a step 622, then the overall location data are refined in a step 624 based on the shared, collected data. The refined location data are then shared among the different detector systems in the navigation system in a step 626, then process 600 ends in an end step 630.

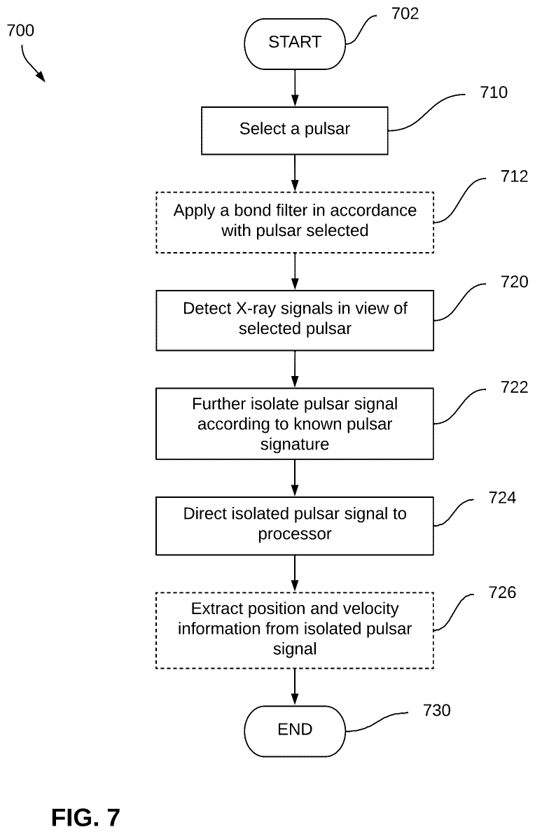

FIG. 7 is a flow diagram of a method for isolating pulsar signals from background X-ray signals, in accordance with an embodiment. A process 700 begins with a start step 702, then proceeds to a step 710 to select a specific pulsar to be observed with a detector within a detector system as described above. In an optional step 712, a band filter may applied to the detector and/or the signal collected at the detector, in accordance with the pulsar selected. As an example, the detector system may include a memory with a library of behavior data for known pulsars, and the band filter may be selected according with the known behavior of the selected pulsar. In other examples, substantially all of the X-ray spectrum may be used by the timing and lateration system without filtering.

Continuing to refer to FIG. 7, in a step 720, X-ray signals are detected in view of the pulsar selected. For instance, a range of X-ray signals may be collected across a field of view of the detector pointed generally toward the selected pulsar. The range of X-ray signals may include both the pulsar signal of the selected pulsar, as well as unwanted background signals. The pulsar signal is further isolated from the background noise, according to the known pulsar signature, in a step 722. For instance, known signal processing methods such as filtering, template matching, and thresholding may be used to further isolate the desired pulsar signals. The isolated pulsar signal data may then be directed to the processor within the detector system and/or the overall navigation system in a step 724. In an optional step 726, the processor may be used to extract position and velocity information for the selected pulsar from the isolated pulsar signal. Process 700 is terminated in an end step 730.

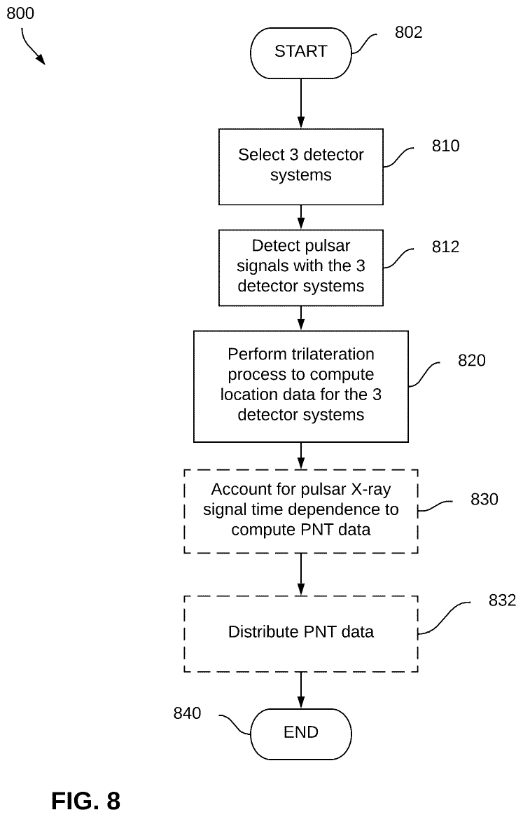

FIG. 8 is a flow diagram of a method for performing pulsar-based trilateration and, optionally, position-navigation-timing (PNT) calculation, in accordance with an embodiment. As shown in FIG. 8, a process 800 begins with a start step 802, then proceeds a step 810 to select at least three detector systems for collection of pulsar data. Optionally, as discussed above, the three different detector systems selected may be periodically, randomly, or pseudo-randomly out of a multitude of detector systems during each pass of process 800 in order to make it difficult for an outside intruder to disrupt the operation of the overall navigation system.

Continuing to refer to FIG. 8, process 800 proceeds to a step 812 to detect pulsar signals with the three selected detector systems. Then, in a step 820, a trilateration process is performed to compute the location data for the three detector systems. The process may optionally proceed to a step 830 to account for the time dependence of the pulsar signals (e.g., known X-ray signal frequency signature) to further calculate PNT data from the pulsar data collected by the three selected detector systems. In another optional step 832, the PNT data may be distributed to other locations, such as ground station 516 and/or ground vehicle 518 of FIG. 5. Process 800 ends in a termination step 840.

A variety of implementations of the pulsar-based timing and lateration system are contemplated. In some cases, a pulsar-based timing a lateration system includes a detector system, wherein the detector system includes a plurality of detectors and an electronics unit. Each detector is configured for detecting X-ray photons and generating output signals according to the X-ray photons so detected. In some cases, each detector may also be a transceiver, including an electromagnetic energy source such as a laser, light emitting diode, or other signal production mechanism, co-located with a sensor such that the transceiver may be configured to both receive and transmit electromagnetic signal. In certain cases, the electronics unit may include circuitry to receive and analyze the output signals from the plurality of detectors. Each one of the detectors may be pointed at different pulsars, certain groups of detectors may be pointed at a specific pulsar, each one of the detectors may sequentially point at different pulsars, or some combination of pointing schemes may be contemplated. In certain cases, each one of the detectors or the detector system as a whole may be mounted on a mechanical or non-mechanical adjustment unit, such as a gimbal, rotation stage, piezoelectric stage, pneumatic stage, motorized stage, or other similar apparatus for providing positional adjustment.

In some embodiments, an analog-to-digital (A/D) converter may be integrated into the electronics unit or each detector. The electronics unit also may include a processor, as a part of or in addition to the circuitry, for analyzing the output signals received from the plurality of detectors. The electronics unit may also include a memory for storing a library of data related to electromagnetic emissions of known pulsars, from some of which the detector system may collect X-ray photons.

In some embodiments, each detector in the detector system is configured for detecting a specific band of X-ray emissions known to be emitted from a particular pulsar. For example, the detector may include a narrowband filter for capturing only X-ray emissions for a wavelength range of interest within which the particular pulsar is known to emit pulsar radiation. As another example, the detector may include an adjustable filter or a plurality of filters for detecting X-ray emissions from pulsars emitting at a variety of wavelengths. The wavelength range of interest may include, for instance, 0.01 to 1 nanometers, 0.01 to 5 nanometers, 1 to 5 nanometers, and 5-10 nanometers. An important aspect of the pulsar-based timing and lateration system of the present disclosure is that the detector system is not required to differentiate between different X-ray energy levels, in contrast to previously disclosed systems such as the NICER system of NASA.

In certain embodiments, the processor is configured for isolating pulsar-specific signals from the X-ray photons detected at one or more of the plurality of detectors by, for instance, filtering the X-ray photon according to the library of data related to electromagnetic emissions from known pulsars. The pulsar-specific signals so isolated may also be compared to the library of data to determine the position and velocity of the pulsar-based timing and lateration system. Additionally, the electronics unit may include a communication unit for receiving and transmitting communications signals to and from the detector system. In other embodiments, the detector system may be coupled with a separate communication unit located within the pulsar-based timing and lateration system.

In some cases, multiple detector systems may be used. For example, two or more detector systems, each including a plurality of detectors, may be positioned spaced apart from each other, such as installed on or within one or more of different satellites, ground stations, spaceborne and/or ground-based vehicles, and other locations. In some cases, the different detector systems may be configured to communicate with a centralized communication hub. As an example, detector systems may be provided at three different locations to communicate the received pulsar signal analysis results amongst the three locations to perform a tri-lateration process, then transmit the positioning and location information extracted from the tri-lateration process to other vehicles and locations that are not equipped with the detector systems as described herein. For instance, such an arrangement of multiple detector systems may be used as an on-the-fly logistics infrastructure that may be set up without reliance on, for example, Global Positioning system (GPS) satellites or equivalents thereof. In fact, as many known pulsars are visible throughout space, such a pulsar-based timing and lateration system may be established anywhere multiple pulsars are viewable, such as in space away from the main earth orbits (e.g., low-earth orbit or geosynchronous equatorial orbit) including during flight, on planets, or other extraterrestrial contexts.

In fact, the use of networked detector systems provide advantages over GPS systems and the like. For instance, a GPS lock (i.e., a GPS receiver being able to accurately compute position and time) requires that the GPS receiver is capable of receiving clean signals from four separate GPS satellites, corresponding to three geospatial signals and one timing signal. Further, existing pulsar-based navigation systems require, for example, Doppler mapping, taking into account the brightness of the Sun at the time of signal capture, and other complications with large, X-ray detectors configured for detecting X-ray radiation over a large range of X-ray wavelengths while distinguishing between X-ray signals within the range of wavelengths. Instead, the detectors used in the detector system of the present disclosure may be provided with fixed narrow- to medium band filters for reducing the range of X-rays that need to be captured for each known pulsar, thus greatly reducing the size and complexity of the X-ray sensors themselves. Further, due to the inherent time-dependence of the pulsar signals, the pulsar-based timing and positioning system of the present disclosure only requires signal capture and analysis from three pulsars for accurate calculation of position and timing.

In certain embodiments, when a multitude of vehicles or locations with the detector systems are connected via a communication network, while traditional signal encryption methods may be used, another layer of encryption may be employed by periodically, randomly, or pseudo-randomly changing the specific detector systems (i.e., detector systems mounted on different vehicles or locations) being used to provide the timing and positioning analysis, thus making the overall pulsar-based timing and lateration system more secure and resilient compared to using only traditional signal encryption methods.

In certain embodiments, a method for using a pulsar-based timing and lateration system including a detector system, in turn including a plurality of detectors. The method includes determining a plurality of pulsars for use in a positioning process, and detecting X-ray emissions from the plurality of pulsars using the plurality of detectors in the detector system. Then, a processor in the pulsar-based timing and lateration system is used to determine location data of the detector system with respect to the plurality of pulsars.

In some cases, multiple detector systems may be included in the pulsar-based timing and lateration system. The multiple detector systems may be spaced apart from each other, or mounted on different satellites, vehicles, or fixed locations, and be configured to communicate with each other. In certain cases, the pulsar data collected at one detector system may be shared with other detector systems in the pulsar-based timing and lateration system to enable further refinement of the location data. In certain embodiments, at least three detector systems are used to gather pulsar emission data, then the received data are combined to perform a tri-lateration process to compute the location data for the at least three detector systems. Optionally, the frequency signatures of the measured pulsars may be taken into account to calculate the position-navigation-timing (PNT) data from the three detector systems. In an embodiment, the location data or PNT data may be transmitted and shared with external devices that are not equipped with the detector system as described herein. In certain examples, the detected X-ray data may be further filtered or refined in order to isolate the pulsar signals from any background radiation signals. For instance, the isolation of the pulsar signal may be performed using a frequency or wavelength filter, or by comparing the detected X-ray data with a library of known pulsar emission signatures stored in a memory within the pulsar-based timing and lateration system.

The foregoing system and methods described above provide several advantages. Accordingly, although the present disclosure has been provided in accordance with the implementations shown, one of ordinary skill in the art will readily recognize that there could be variations to the embodiments and those variations would be within the scope of the present disclosure. Therefore, many modifications may be made by one of ordinary skill in the art without departing from the scope of the appended claims.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding”— whether explicitly discussed or not—and, conversely, were there only disclosure of the act of “protruding,” such a disclosure should be understood to encompass disclosure of a “protrusion.” Such changes and alternative terms are to be understood to be explicitly included in the description.

1. A pulsar-based timing and lateration system, the system comprising:
a detector system including
a plurality of detectors, each one of the plurality of detectors is configured for detecting X-ray photons and generating output signals according to the X-ray photons so detected, and
an electronics unit for receiving and analyzing the output signals from the plurality of detectors,
wherein the electronics unit includes a processor for analyzing the output signals received from the plurality of detectors,
wherein a first one of the plurality of detectors is aimed toward a first pulsar such that the X-ray photons detected at that one of the plurality of detectors includes pulsar signals from the first pulsar,
wherein the processor includes a memory for storing a library of data related to electromagnetic emissions of known pulsars, and
wherein the processor is configured for
isolating the pulsar signals from the first pulsar, and
determining position and velocity of the system by comparing the pulsar signals from the first pulsar so isolated to the library of data.

2. The system of claim 1, wherein the electronics unit further includes a plurality of converters,
each one of the plurality of converters being configured for
receiving output signals from a corresponding one of the plurality of detectors,
converting the output signals so received into digital signals, and
directing the digital signals to the processor.

3. The system of claim 1, wherein each one of the plurality of detectors is configured for detecting X-ray photons within a range of wavelengths of interest within an X-ray spectrum.

4. The system of claim 1, wherein the range of wavelengths includes at least one of 0.01 to 1 nanometers, 0.01 to 5 nanometers, 1 to 5 nanometers, and 5-10 nanometers.

5. The system of claim 1, further comprising a plurality of detector systems, each one of the plurality of detector systems being spaced apart from each other one of the plurality of detector systems.

6. The system of claim 5, wherein each one of the plurality of detector systems includes a communication unit for communicating with each other one of the plurality of detector systems.

7. The system of claim 5, wherein each one of the plurality of detector systems includes a communication unit for communicating with a communication hub.

8. The system of claim 5, wherein each one of the plurality of detector systems is disposed on a satellite.

9. The system of claim 1, wherein each one of the plurality of detectors points in a different direction from each other one of the plurality of detectors.

10. The system of claim 9, wherein the plurality of detectors is configured to collect pulsar signals from a plurality of pulsars without moving the detector system.

11. The system of claim 9, wherein at least one of the plurality of detectors is coupled with a mechanical arrangement for adjusting a pointing direction of the at least one of the plurality of detectors.

12. The system of claim 11, wherein the mechanical arrangement includes a gimbal.

13. A method for using a pulsar-based timing and lateration system, the pulsar-based timing and lateration system including a detector system, the method comprising:
determining a plurality of pulsars for use in a positioning process;
using detector system for detecting the plurality of pulsars;
further using the detector system for determining location data of the detector system with respect to the plurality of pulsars.

14. The method of claim 13, wherein the detector system is a first detector system and the pulsar-based timing and lateration system further comprises a second detector system, the method further comprising:
transferring the location data of the first detector system to the second detector system;
using the second detector system to determine location data of the second detector system with respect to the plurality of pulsars; and
refining the location data of the second detector system to generate a refined location data of the second detector system by comparing the location data of the first detector system with the location data of the second detector system with respect to the plurality of pulsars.

15. The method of claim 14, further comprising:
transferring the refined location data of the second detector system to the first detector system; and
refining the location data of the first detector system to generate a refined location data of the first detector system by comparing the location data of the first detector system with the refined location data of the second detector system.

16. The method of claim 14, the pulsar-based timing and lateration system further comprising a third detector system, the method further comprising:
transferring the location data of the first detector system and the second detector system to the third detector system;
using the third detector system to determine location data of the third detector system with respect to the plurality of pulsars; and
transmitting the location data of the first detector system, the second detector system, and the third detector system to a remote object to perform a trilateration analysis to determine location data of the remote object, the remote object being located remotely from the first, second, and third detector systems.

17. The method of claim 13, wherein using the detector system includes:
selecting a specific pulsar from the plurality of pulsars;
collecting X-ray photons from a general direction of the specific pulsar so selected;
isolating a pulsar signal from the X-ray photons so collected; and
analyzing the pulsar signal to determine at least one of positioning information, navigation information, and timing information of the detector system.

18. The method of claim 17, further comprising distributing the at least one of positioning information, navigation information, and timing information of the detector system to other locations within the pulsar-based timing and lateration system.

19. The method of claim 17,
wherein the detector system further includes a memory for storing a library of data related to electromagnetic emissions of known pulsars, and
wherein analyzing the pulsar signal further includes comparing the pulsar signal to a portion of the library of data as related to electromagnetic emissions of the specific pulsar.
